(19) United States
(12) Patent Application Publication
(10) Pub. No.: US 2025/0175835 A1
(43) Pub. Date: May 29, 2025

(54) METHOD, DEVICE, AND SYSTEM FOR RESOURCE STATUS REPORT IN WIRELESS NETWORKS

(71) Applicant: ZTE CORPORATION, Shenzhen, Guangdong (CN)

(72) Inventors: Xiubin SHA, Shenzhen, Guangdong (CN); Bo DAI, Shenzhen, Guangdong (CN); He HUANG, Shenzhen, Guangdong (CN); Yuan GAO, Shenzhen, Guangdong (CN); Ting LU, Shenzhen, Guangdong (CN); Li NIU, Shenzhen, Guangdong (CN); Jie TAN, Shenzhen, Guangdong (CN)

(21) Appl. No.: 18/839,724

(22) PCT Filed: Apr. 22, 2022
(86) PCT No.: PCT/CN2022/088620

§ 371 Date: Aug. 19, 2024

(51) Int. Cl. H04W 24/10; H04W 72/0453; H04W 72/0457

(52) U.S. Cl. CPC H04W 24/10; H04W 72/0453; H04W 72/0457

(57) ABSTRACT

This disclosure relates generally to a method, device, and system for saving Network Element (NE) power consumption in wireless communications. One method performed by a first NE including transmitting a first message to a second NE in the wireless network, the first message comprising a request for resource status information, wherein the request applies to at least one of the following levels: a beam level; a carrier level; a cell level; a network slice level; or a frequency range level.

### TECHNICAL FIELD

This disclosure is directed generally to wireless communications, and particularly to a method, device, and system for resource status request and report in a wireless network.

### BACKGROUND

Energy efficiency is a key performance index in the wireless communication network. Controlling power consumption and reducing energy cost is critical for developing and deploying a wireless communication network. Energy saving technology plays an essential role in achieving this goal. From a User Equipment (UE) perspective, UE battery life has great impact on user experience. From a network perspective, energy consumption is a key factor to consider for improving investment efficiency for operators. It is beneficial to have the capability to dynamically control the power consumption of various network elements and/or UEs yet still meet a performance requirement.

### SUMMARY

This disclosure is directed to a method, device, and system for saving network element power consumption in a wireless network.

In some embodiments, a method performed by a first Network Element (NE) in a wireless network is disclosed. The method may include: transmitting a first message to a second NE in the wireless network, the first message comprising a request for resource status information, wherein the request applies to at least one of the following levels: a beam level; a carrier level; a cell level; a network slice level; or a frequency range level.

In some embodiments, a method performed by a first Network Element (NE) in a wireless network is disclosed. The method may include: receiving a first message from a second NE in the wireless network, the first message comprising a request for resource status information, wherein the request applies to at least one of the following levels: a beam level; a carrier level; a cell level; a network slice level; or a frequency range level.

In some embodiments, there is network element comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments.

The above embodiments and other aspects and alternatives of their implementations are described in greater detail in the drawings, the descriptions, and the claims below.

### BRIEF DESCRIPTION OF DRAWINGS

FIG. 1A shows an example wireless communication network.

FIG. 1B shows an example Open Radio Access Network (O-RAN).

FIG. 2 shows an example wireless network node.

FIG. 3 shows an example user equipment.

FIG. 4 shows an exemplary message flow for resource status request.

FIG. 5 shows another exemplary message flow for resource status request.

FIG. 6 shows an exemplary resource status update.

### DETAILED DESCRIPTION

### Wireless Communication Network

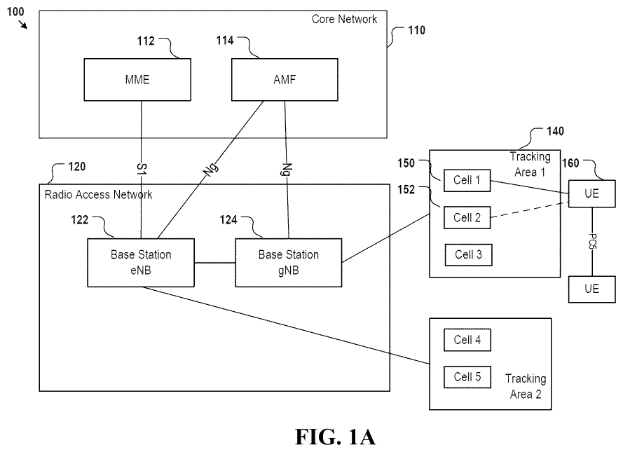

FIG. 1A shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1A. The RAN 120 further includes multiple base stations, for example, base stations 122 and 124. The base stations may include at least one evolved NodeB (eNB) for 4G LTE, or a Next generation NodeB (gNB) for 5G New Radio (NR), or any other type of signal transmitting/receiving device such as a UMTS NodeB. The eNB 122 communicates with the MME 112 via an S1 interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the DU may be co-located in a same location, or they may be split in different locations. The CU and the DU may be connected via an F1 interface. Alternatively, for an eNB which is capable of connecting to the 5G network, it may also be similarly divided into a CU and at least one DU, referred to as ng-eNB-CU and ng-eNB-DU, respectively. The ng-eNB-CU and the ng-eNB-DU may be connected via a W1 interface.

The wireless communication network 100 may include one or more tracking areas. A tracking area may include a set of cells managed by at least one base station. For example, tracking area 1 labeled as 140 includes cell 1, cell 2, and cell 3, and may further include more cells that may be managed by other base stations and not shown in FIG. 1A. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, Internet of Things (IoT) devices, MTC/eMTC devices, distributed remote sensor devices, roadside assistant equipment, XR devices, and desktop computers. The UE 160 may also be generally referred to as a wireless communication device, or a wireless terminal. The UE 160 may support sidelink communication to another UE via a PC5 interface.

In some example implementations, as shown in FIG. 1B, the RAN 120 may be implemented as O-RAN 170. The O-RAN 170 may include a non-real-time RAN Intelligent Controller (non-RT RIC) 171. The non-RT RIC 171 may provide a logical function that enables non-real-time control and optimization of RAN elements and resources, Artificial Intelligence/Machine Learning (AI/ML) workflow including model training and updates, and policy-based guidance of applications/features in near-real-time RAN Intelligent Controller (near-RT RIC) 172. The near-RT RIC 172 may provide a logical function that enables near-real-time control and optimization of O-RAN elements and resources via fine-grained data collection and actions over E2 interface (e.g., E2-DU, E2-CP, and E2-UP). The O-RAN 170 may also include an O-RAN Central Unit (O-CU), which is a logical node hosting RRC, Service Data Adaption Protocol (SDAP) and Packet Data Convergence Protocol (PDCP). Logically, the O-CU may be split into O-CU-CP 173 for control plane and O-CU-UP 174 for user plane. The O-RAN 170 may also include an O-RAN Distributed Unit (O-DU) 175, which is a logical node hosting these layers: Radio Link Control (RLC), Medium Access Control (MAC), and High-Physical (High-PHY) layer, based on a lower layer functional split. The O-RAN 170 may further include an O-RAN Radio Unit (O-RU) 176, which is a logical node hosting Low-Physical (Low-PHY) layer and Radio Frequency (RF) processing based on a lower layer functional split.

In an O-RAN deployment, similar information exchange procedure between gNB-CU and gNB-DU may be used for information exchange between RIC (e.g., non-RT RIC, or near-RT RIC) and O-CU, between RIC and O-DU, between Operation and Maintenance function/entity (OAM) and DU, or between OAM and CU.

While the description below focuses on cellular wireless communication systems as shown in FIG. 1A and FIG. 1B, the underlying principles are applicable to other types of wireless communication systems for paging wireless devices. These other wireless systems may include but are not limited to Wi-Fi, Bluetooth, ZigBee, and WiMax networks.

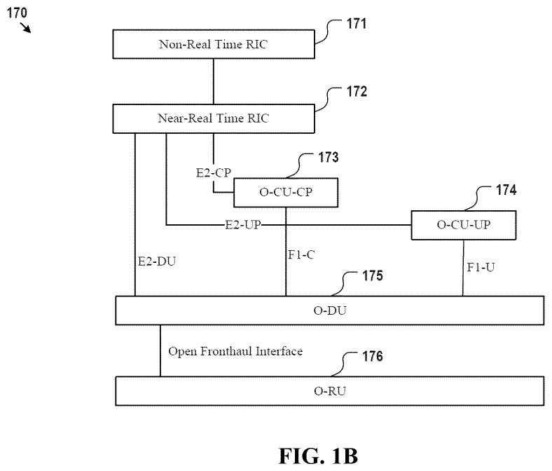

FIG. 2 shows an example of electronic device 200 to implement a network base station (e.g., a radio access network node), a core network (CN), and/or an operation and maintenance (OAM). Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

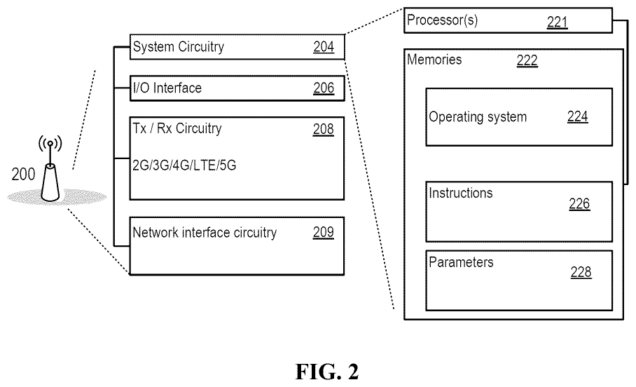

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA) +, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

### RAN Node Interaction

Energy consumption has become a key part of the operators' operating expenses (OPEX). In wireless networks, significant energy consumption comes from the radio access network and in particular from the hardware circuitries such as Active Antenna Unit (AAU), Radio Unit (RU), Remote Radio Unit (RRU), Power Amplifier (PA), and the like.

Usually, to save power consumption of a radio access (e.g. the gNB power consumption), the network equipment (e.g. cell, carrier, channel, slot, symbol, etc.) are dynamically shutoff during the light load duration with the condition that user experience (e.g. user perceived throughput, latency, UE power consumption, etc.) are not impacted.

In the wireless network, one mechanism for saving network energy consumption is to aggregate or transfer partial or all load from one network element to another network element and shutoff partial or all of relevant resources and their corresponding hardware circuitry. For example, multiple RAN nodes (e.g., gNBs, eNBs, or ng-eNBs, or a combination thereof) may interact with each other so each node may acquire a snapshot of resource status in other nodes. The resources may include: cell, carrier, beam, network slice, Bandwidth Part (BWP), bandwidth represented by a frequency range, slot, or symbol. With this snapshot, a RAN node may make a more informed decision, for example, when attempting to transfer certain traffic or service to another RAN node, and achieving a higher successful transfer rate while maintaining the service requirement such as a Quality of Service (QOS) requirement. As some load is offloaded, it is possible for the RAN node to dynamically shutdown certain resources and their corresponding hardware circuitry, to save energy. Load aggregation may be implemented in various levels corresponding to different granularities. For example, a whole carrier may be shutdown, if the traffic supported by the carrier may be covered by another carrier in another RAN node. For another example, a beam may be shutdown, if another beam may be utilized for offloading the traffic. For another example, an under-used frequency range may be shutdown, e.g., a frequency range not used by any UEs, to save the operating cost of related hardware. Therefore, it is important for the RAN nodes to be able to request and report resource status with each other. It is also important to implement the resource status exchange that covers different levels, such as cell level, carrier level, beam level, BWP level, slot/symbol level, etc.

Not only the resource status information may be exchanged between RAN nodes, it may also be exchanged between gNB-CU and gNB-DU. In an O-RAN deployment, the resource status information may also be exchanged between a RIC and an O-CU or an O-DU.

### Embodiment 1: Resource Status Request Initiation with Acknowledge

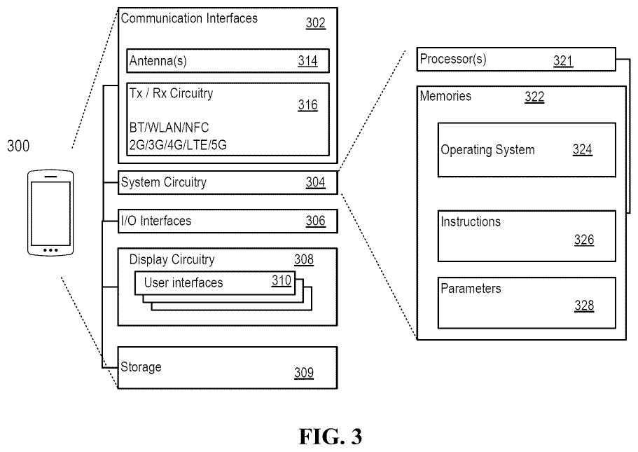

FIG. 4 illustrates an example message flow for initiating resource status report with Acknowledge.

### Step 1

RAN node 1 may initiate the resource status reporting procedure by sending a resource status request message to RAN node 2 requesting RAN node 2 to start a measurement and report back measurement result. The RAN node 1 may include one of: a gNB, an eNB, an ng-eNB, or a gNB-CU. The RAN node 2 may include one of: a gNB, an eNB, an ng-eNB, or a gNB-DU. If an O-RAN is deployed in the wireless network, the RAN node 1 may further include a RIC, or an Operation and Maintenance (OAM) entity, and the RAN node 2 may further include a RIC, an O-CU, or an O-DU.

The resource status request may indicate a desired level for the report. The desired level may include at least one of:
a beam level;
a carrier level;
a cell level;
a network slice level; or
a frequency range level.

For example, the beam level may apply to a report which targets resources per beam in a cell, or per beam identified in the resource request message, etc.

In one implementation, the level may be combined. For example, a desired level may include per carrier per cell, so the report may target carriers in a particular cell, or carriers in a list of cells. A level may also be a conditional level, for example, per cell that is used as a Primary cell, or a Secondary cell. An example list of desired levels is listed below:
per cell;
per cell that is used as a Primary cell (Pcell);
per cell that is used as a Primary Secondary cell group cell (PScell);
per cell that is used as a Secondary cell (Scell);
per beam;
per beam in a cell that is used as a Pcell;
per beam in a cell that is used as a PScell;
per a beam in a cell that is used as a Scell;
per carrier;
per carrier in a cell that is used as a Pcell;
per carrier in a cell that is used as a PScell;
per carrier in a cell that is used as a Scell;
per carrier per beam in a cell that is used as a Pcell;
per carrier per beam in a cell that is used as a PScell; or
per carrier per beam in a cell that is used as a Scell.

The resource status request may apply to different types of resources, i.e., resources in different categories. The resource category may include at least one of:
a number of active User Equipments (UEs);
an Uplink (UL) Physical Resource Block (PRB) usage;
a Downlink (DL) PRB usage;
a UL scheduling Physical Downlink Channel (PDCCH) Control Channel Element (CCE) usage;
a DL scheduling PDCCH CCE usage;
a DL Guaranteed Bit Rate (GBR) PRB usage;
a UL GBR PRB usage;
a DL non-GBR PRB usage;
a UL non-GBR PRB usage;
a list of active carriers;
a list of idle carriers;
measured neighbor cell Reference Signal Received Power (RSRP);
a Synchronization Signal/Physical Broadcast Channel (PBCH) Block (SSB) Transmission (Tx) power information; or
a Channel State Information Reference Signal (CSI-RS) Tx power information.

Further, a resource status request may combine the resource category, and a desired level. Using “a number of active UEs” as a resource category, different combinations may be made. Various sample combinations are listed below:
a number of active UEs per cell that the cell is used as a Pcell;
a number of active UEs for all cells that are used as a Pcell;
a number of active UEs per beam that the cell is used as Pcell;
a number of active UEs per beam that the cell is used as PScell;
a number of active UEs per beam that the cell is used as Scell;
a number of active UEs per carrier;
a number of active UEs per carrier that the cell is used as Pcell;
a number of active UEs per carrier that the cell is used as PScell;
a number of active UEs per carrier that the cell is used as Scell;
a number of active UEs per carrier per beam that the cell is used as Pcell;
a number of active UEs per carrier per beam that the cell is used as PScell; or
a number of active UEs per carrier per beam that the cell is used as Scell.

In one implementation, the number of active UEs may be measured as the mean number of UEs in a beam, a carrier, or a cell, during a reporting periodicity, for which there is data available for uplink (UL) transmission (e.g., UL Data Radio Bearers (DRBs)), or there is data available for downlink (DL) transmission (e.g., DL DRBs), or both.

In one implementation, the number of active UEs may be measured as the maximum number of UEs in a beam, a carrier, or a cell, during a reporting periodicity, for which there is data available for uplink (UL) transmission (e.g., UL DRBs), or there is data available for downlink (DL) transmission (e.g., DL DRBs), or both.

In one implementation, a resource usage such as a UL GBR PRB usage, may be represented by one of: a resource occupied rate; or a resource un-occupied rate.

In one implementation, in the resource status request, a cell may be identified by a cell identifier, such as a New Radio Cell Global Identifier (NR CGI); a carrier may be identified by a carrier index; and a beam may be identified by its associated SSB index.

In one implementation, the resource request may target a list of objects, for example, by using an SSB index list (to represent a list of beams), a carrier index list (to represent a list of carriers), or a cell list (to represent a list of cells).

In one implementation, if the desired level is a network slice level, a per slice configuration may additionally be requested and be used to help assuring a dynamic Service Level Agreement (SLA) requirement.

In one implementation, if the desired level is a frequency range level, the frequency range may also be specified in the request. The requested frequency range may be configurable via, for example, additional signaling.

In one implementation, the RAN node 1 may request the resource status report to be sent in different manners. For example, the request may include an on-demand type. In this case, the RAN node 2 responds with a resource measurement result in one shot. The request may also include a conditional report type (event report type or triggered report type). In this case, the RAN node 2 sends the resource measurement result only when a condition is met or a threshold is reached. The condition or the threshold may be predetermined, and may be configurable. The request may also include a periodic report type. In this case, the RAN node 2 periodically sends the resource measurement result following a periodicity. The periodicity may be predetermined, and may be configurable.

### Step 2

RAN node 2, upon receiving the resource status request, determines that it supports measuring, collecting, or reporting partial or all the resource status information requested by the RAN node 1. RAN node 2 may reply with an acknowledgement to the RAN node 1.

In one implementation, if the resource status request is of on-demand type, the RAN node 2 may reply back with resource status information as requested. The resource status information may be sent in the same acknowledgement message, or via another message.

In one implementation, if the resource status request is of conditional report type, RAN node 2 will send resource status information to RAN node 1, if the report condition is met, or the threshold is reached. The resource status information may be sent via another message, which will be described in detail in later section.

In one implementation, if the resource status request is of periodic report type, RAN node 2 will send resource status information to RAN node 1 periodically. The resource status information may be sent via another message, which will be described in detail in later section.

### Embodiment 2: Resource Status Request Initiation With Failure Response

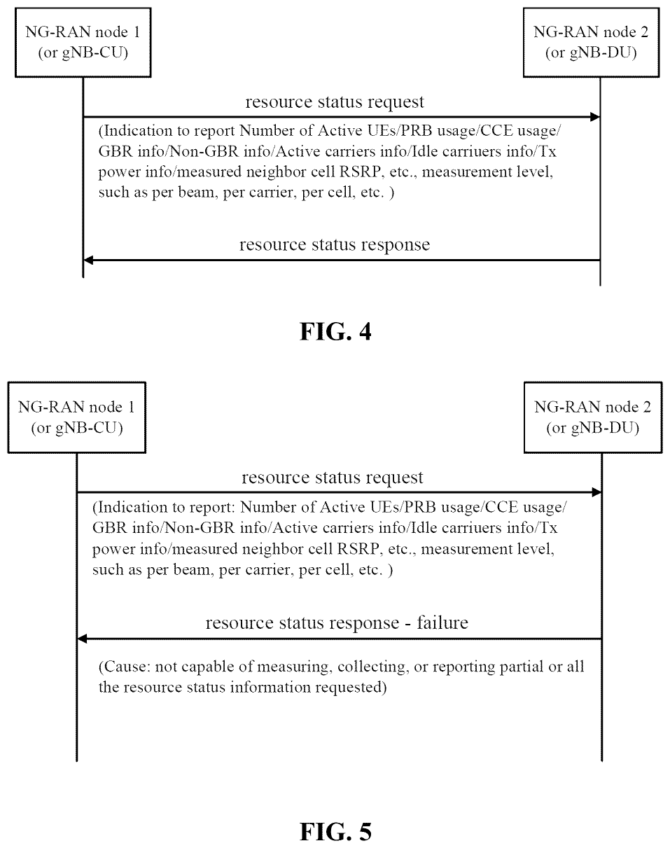

In this embodiment, an error condition is encountered. Referring to FIG. 5, RAN node 1 initiates a resource status request, which is similar to step 1 in embodiment 1 above.

In this embodiment, RAN node 2 determines that it is not capable of measuring, collecting, or reporting partial or all the resource status information as requested by RAN node 1. The RAN node 2 may response to the request with a failure and a cause of the failure. For example, the cause may be partial of the resource status information is not supported, or all of the resource status information is not supported. The response may also include a list of resources and/or levels that RAN node 2 does not support.

### Embodiment 3: Resource Status Update

This embodiment may serve as a continuation of embodiment 1. RAN node 2 receives a resource status request from RAN node 1, and RAN node 2 is capable of supporting the request. As described above, the resource status request may include a list of various resources combined with a corresponding level. For example, the request may include resource such as “number of active UEs”, and a corresponding level may include one of: per beam, per cell that is used as a Pcell, per beam per cell that is used as a Pcell, per carrier, per carrier per cell that is used as a Pcell, per carrier per beam per cell that is used as a Pcell, etc. the cell(s), and/or the carrier(s) may be explicitly specified in the request message.

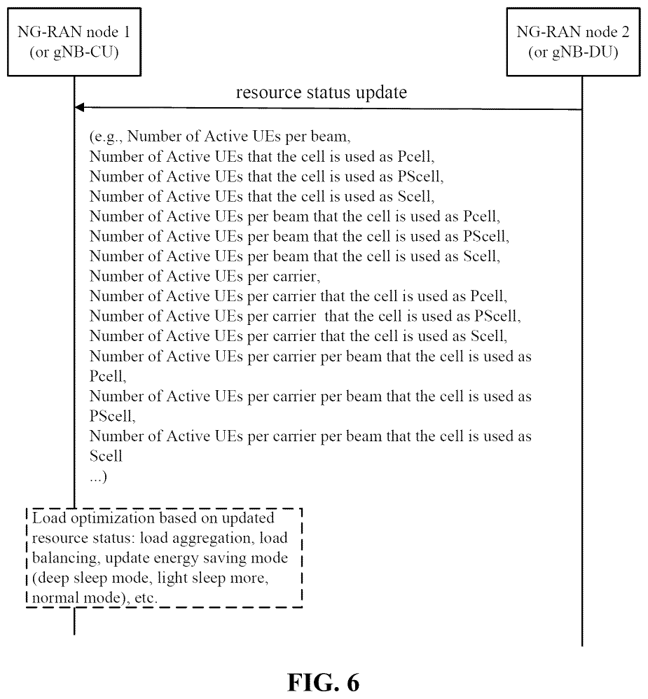

Referring to FIG. 6, this embodiment may include following steps.

### Step 1

After receiving the resource status request message, RAN node 1 may start to measure or collect resource status information as requested. RAN node 2 may then send a resource status update message to RAN node 1, to report back the resource status information.

In one implementation, the resource status request is on-demand report type, then the resource status update message will be one shot.

In one implementation, the resource status request is conditional report type, then RAN node 2 check report condition and/or the threshold. If the report condition is met and/or the threshold is reached, the RAN node 2 may send the resource status update to RAN node 1.

In one implementation, the resource status request is periodic report type, RAN node 2 may send the resource status update periodically, following a predetermined and adjustable periodicity.

As an example, the resource status update may include:
UL PRB usage per carrier,
UL PRB usage per carrier for a cell used as Pcell,
UL PRB usage per carrier for a cell used as PScell,
UL PRB usage per carrier for a cell used as Scell,
UL PRB usage per beam for a cell used as Pcell,
UL PRB usage per beam for a cell used as PScell,
UL PRB usage per beam for a cell used as Scell,
UL PRB usage per carrier per beam for a cell used as Pcell,
UL PRB usage per carrier per beam for a cell used as PScell,
UL PRB usage per carrier per beam for a cell used as Scell.

For another example, the resource status update may include:
UL scheduling PDCCH CCE usage per carrier for a cell used as Pcell,
UL scheduling PDCCH CCE usage per carrier for a cell used as PScell,
UL scheduling PDCCH CCE usage per carrier for a cell used as Scell,
UL scheduling PDCCH CCE usage per beam for a cell used as Pcell,
UL scheduling PDCCH CCE usage per beam for a cell used as PScell,
UL scheduling PDCCH CCE usage per beam for a cell used as Scell.
UL scheduling PDCCH CCE usage per carrier per beam for a cell used as Pcell,
UL scheduling PDCCH CCE usage per carrier per beam for a cell used as PScell,
UL scheduling PDCCH CCE usage per carrier per beam for a cell used as Scell.

For another example, the resource status update may include:
UL GBR PRB usage per carrier,
UL GBR PRB usage per carrier for a cell used as Pcell,
UL GBR PRB usage per carrier for a cell used as PScell,
UL GBR PRB usage per carrier for a cell used as Scell,
UL GBR PRB usage per beam for a cell used as Pcell,
UL GBR PRB usage per beam for a cell used as PScell,
UL GBR PRB usage per beam for a cell used as Scell.
UL GBR PRB usage per carrier per beam for a cell used as Pcell,
UL GBR PRB usage per carrier per beam for a cell used as PScell,
UL GBR PRB usage per carrier per beam for a cell used as Scell.

For another example, the resource status update may include:
active carrier indication (such as active carrier list) in a cell,
idle carrier indication (such as idle carrier list) in a cell,
SSB Tx power information per cell,
SSB Tx power information per beam,
CSI-RS Tx power information per cell,
CSI-RS Tx power information per beam,
Received neighbor cell Tx power (e.g. measured neighbor cell's RSRP) per cell,
Received neighbor cell Tx power per beam.

In one implementation, for the measurement result in the resource status update, a cell may be identified by a cell identifier, such as a NR CGI; a carrier may be identified by a carrier index; and a beam may be identified by its associated SSB index.

In one implementation, the measurement result may target a list of objects, for example, by using an SSB index list (to represent a list of beams), a carrier index list (to represent a list of carriers), or a cell list (to represent a list of cells).

### Step 2

Based on updated resource status information, RAN node 1 may now determine whether certain traffic or service may be aggregated/transferred, either within RAN node 1 itself, or to another RAN node. After traffic or service being transferred, RAN node 1 may further shutdown corresponding resources, and hardware circuitries; or RAN node 1 may switch its power saving mode, for example, to a deep sleep mode.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1. A method for a resource status report in wireless communication, performed by a first Network Element (NE) in a wireless network, the method comprising:
transmitting a first message to a second NE in the wireless network, the first message comprising a request for resource status information, wherein the request applies to at least one of the following levels:
a beam level;
a carrier level;
a cell level;
a network slice level; or
a frequency range level.

2. The method of claim 1, further comprising:
receiving, from the second NE, a response to the first message, the response indicating whether the second NE is capable of measuring, collecting, or reporting partial or all the resource status information requested by the first NE.

3. The method of claim 1, wherein the frequency range level corresponds to a Bandwidth Part (BWP).

4. The method of claim 1, wherein:
in response to the request applying to the beam level, the request further comprises a beam identifier which identifies a beam in a cell of the second NE;
in response to the request applying to the carrier level, the request further comprises a carrier identifier which identifies a carrier in the cell of the second NE;
in response to the request applying to the cell level, the request further comprises a cell identifier which identifies a cell of the second NE;
in response to the request applying to the network slice level, the request further comprises a network slice identifier which identifies a network slice; or in response to the request applying to the frequency range level, the request further comprises an indication for a frequency range.

5. The method of claim 4, wherein the beam identifier comprises a Synchronization Signal/Physical Broadcast Channel (PBCH) Block (SSB) index associated with the beam.

6. The method of claim 1, wherein a type of the request comprises at least one of:
an on-demand type, wherein, in response to the request being the on-demand type, the second NE responds with a resource measurement result in one shot;
a conditional report type, wherein, in response to the request being the conditional report type, the second NE sends the resource measurement result only when a condition is met or a threshold is reached; or
a periodic report type, wherein, in response to the request being the periodic report type, the second NE periodically sends the resource measurement result following a periodicity.

7. The method of claim 6, wherein:
in response to the type of the request being the conditional report type, the request further comprises the condition to be met or the threshold to be reached to trigger the second NE to send the resource measurement result; and
in response to the type of the request being the periodic report type, the request further comprises the periodicity.

8. The method of claim 1, wherein the request comprises a measurement category list, the measurement category list comprising at least one of:
a number of active User Equipments (UEs);
an Uplink (UL) Physical Resource Block (PRB) usage;
a Downlink (DL) PRB usage;
a UL scheduling Physical Downlink Channel (PDCCH) Control Channel Element (CCE) usage;
a DL scheduling PDCCH CCE usage;
a DL Guaranteed Bit Rate (GBR) PRB usage;
a UL GBR PRB usage;
a DL non-GBR PRB usage;
a UL non-GBR PRB usage;
a list of active carriers;
a list of idle carriers;
a neighbor cell Reference Signal Received Power (RSRP);
an SSB Transmission (Tx) power information; or
a Channel State Information Reference Signal (CSI-RS) Tx power information.

9. The method of claim 8, wherein each entry in the measurement category list is associated with a measurement level in a measurement level list, the measurement level list comprising at least one of:
a cell;
a cell that is used as a Primary cell (Pcell);
a cell that is used as a Primary Secondary cell group cell (PScell);
a cell that is used as a Secondary cell (Scell);
a beam;
a beam in a cell that is used as a Pcell;
a beam in a cell that is used as a PScell;
a beam in a cell that is used as a Scell;
a carrier;
a carrier in a cell that is used as a Pcell;
a carrier in a cell that is used as a PScell;
a carrier in a cell that is used as a Scell;
a carrier per beam in a cell that is used as a Pcell;
a carrier per beam in a cell that is used as a PScell; or
a carrier per beam in a cell that is used as a Scell.

10. The method of claim 9, further comprising:
receiving, from the second NE, a resource status report message comprising the resource status information, the resource status information comprising a list of measurement reports, wherein:
each entry in the list of measurement reports is associated with a measurement category in the measurement category list; and
the measurement category in the measurement category list is further associated with a measurement level in the measurement level list.

11. (canceled)

12. The method of claim 1, wherein a type of the first NE comprises at least one of:
a Radio Access Network (RAN) node comprising one of: a gNodeB (gNB), an eNodeB (eNB), or an ng-eNB; or
a gNB Central Unit (gNB-CU); and
wherein the first NE comprises a first component in an Open Radio Access Network (O-RAN), the first component in the O-RAN comprises at least one of:
a RAN Intelligent Controller (RIC); or
an Operation and Maintenance (OAM).

13. (canceled)

14. The method of claim 1, wherein a type of the second NE comprises at least one of:
a Radio Access Network (RAN) node comprising one of: a gNodeB (gNB), an eNodeB (eNB), or an ng-eNB; or
a gNB Distributed Unit (gNB-DU); and
wherein the second NE comprises a second component in an O-RAN, the second component in the O-RAN comprises at least one of:
a RIC;
an Open Central Unit (O-CU); or
an Open Distributed Unit (O-DU).

15. (canceled)

16. A method for a resource status report in wireless communication, performed by a second Network Element (NE) in a wireless network, the method comprising:
receiving a first message from a first NE in the wireless network, the first message comprising a request for resource status information, wherein the request applies to at least one of the following levels:
a beam level;
a carrier level;
a cell level;
a network slice level; or
a frequency range level.

17. The method of claim 16, further comprising:
transmitting, to the first NE, a response to the first message, the response comprising one of:
a first response indicating that the first NE is capable of measuring, collecting, or reporting partial or all the resource status information requested by the first NE; or
a second response indicating that the first NE is not capable of measuring, collecting, or reporting partial or all the resource status information requested by the first NE.

18-19. (canceled)

20. The method of claim 16, wherein request comprises a measurement category list, the measurement category list comprising at least one of:
a number of active User Equipments (UEs);
an Uplink (UL) Physical Resource Block (PRB) usage;
a Downlink (DL) PRB usage;
a UL scheduling Physical Downlink Channel (PDCCH) Control Channel Element (CCE) usage;
a DL scheduling PDCCH CCE usage;
a DL Guaranteed Bit Rate (GBR) PRB usage;
a UL GBR PRB usage;
a DL non-GBR PRB usage;
a UL non-GBR PRB usage;
a list of active carriers;
a list of idle carriers;
an SSB Transmission (Tx) power information; or
a CSI-RS Tx power information.

21. (canceled)

22. The method of claim 20, further comprising:
transmitting, to the first NE, a resource status report message comprising the resource status information, the resource status information comprising a list of measurement reports, wherein:
each entry in the list of measurement reports is associated with a measurement category in the measurement category list; and
the measurement category in the measurement category list is further associated with a measurement level in the measurement level list.

23. The method of claim 22, wherein transmitting the resource status report message comprises one of:
transmitting the resource status report message as a one-shot response to the first message;
in response to a condition being met or a threshold being reached, transmitting the resource status report message; or
transmitting the resource status report message periodically.

24-26. (canceled)

27. The method of claim 16, wherein the first NE comprises a second component in an Open Radio Access Network (O-RAN), the second component in the O-RAN comprises at least one of a RIC; or an OAM.

28. A device for wireless communication comprising a memory for storing computer instructions and a processor in communication with the memory, wherein, when the processor executes the computer instructions, the processor is configured to implement a method for a resource status report in wireless communication,
wherein the method for resource status report in wireless communication comprises:
transmitting a first message to a second NE in the wireless network, or, receiving a first message from a first NE in the wireless network, wherein the first message comprising a request for resource status information, and the request applies to at least one of the following levels:
a beam level;
a carrier level;
a cell level;
a network slice level; or
a frequency range level.

29. A non-transitory computer-readable storage medium comprising a program with computer code stored thereupon, the computer code, when executed by one or more processors, causing the one or more processors to implement the method for resource status report in wireless communication of claim 1.
